(19) United States
(12) Patent Application Publication
(10) Pub. No.: US 2014/0219049 A1
(43) Pub. Date: Aug. 7, 2014

(54) Apparatus for restricting bail or handle movements in mixer

(71) Applicants: Pentti Airaksinen, Oulu (FI); Toni Airaksinen, Oulu (FI)

(72) Inventors: Pentti Airaksinen, Oulu (FI); Toni Airaksinen, Oulu (FI)

(73) Assignee: XEMEC OY, Oulu (FI)

(21) Appl. No.: 14/131,356

(22) PCT Filed: Jul. 5, 2012
(86) PCT No.: PCT/FI2012/050705

§ 371 Date: Apr. 4, 2014

(30) Foreign Application Priority Data
Jul. 8, 2011 (FI) 20115737

(51) Int. Cl. B01F 15/00

(52) U.S. Cl. CPC B01F 15/00766
USPC 366/209

(57) ABSTRACT

The invention relates to an apparatus for restricting the movements of a bail (3) or handles (3′) of a can (1) with contents to be mixed, such as a paint can, in a mixer in which the can is pressed between two support surfaces (2a, 2b) in the direction of its longitudinal axis for the duration of mixing movements. The apparatus comprises at least one restraint (4, 5) arranged on one support surface (2a, 2b) and extending to selected portions on the periphery and the height of the can (1), the bail or the handles being at least partly at this restraint and within it.

### BACKGROUND OF THE INVENTION

The invention relates to an apparatus for restricting the movements of a can with contents to be mixed, such as a paint can, in a mixer in which the can is pressed between two support surfaces in the longitudinal direction thereof during the mixing movements, the apparatus comprising at least one restraint provided on one support surface and extending on selected portions of the can periphery and height, the bail or handles being at least partly at this restraint and within it.

The contents of paint cans are usually mixed by causing the cans to move in different rotating/reciprocating movements. In that case the paint is subjected to accelerations of varying magnitudes and directions, whereby internal flows cause the paint to mix.

For ease of carriage and use, large paint cans must be provided with one or more bails or handles attached thereto. During mixing, these are subjected to similar varying forces as the paint inside. This makes the bails or handles swing freely in their joints during the mixing process. Freely swinging bails or handles are easily damaged when hitting objects that are stationary in relation to them. This may have serious consequences particularly when a bail is torn off. In that case the paint can may be torn broken and the entire product be lost. A yet greater inconvenience is caused to the mixer itself, which may even become damaged beyond repair as paint penetrates into the sensitive wires, bearings, mechanisms or control systems of the mixer.

An attempt to eliminate the above serious drawbacks has been to fasten bails or handles by various detachable auxiliary means. Examples of these include springs, rubber bands, hooks, tapes, magnets, etc. A disadvantage of these is the expensive working time taken for attaching and detaching them. This loss of time affects the mixer operator and typically the client as well. The time lost easily extends the time the apparatus pays for itself by tens of percents.

Another approach has been to provide the mixers with different mechanical auxiliary devices. Examples of these are known from WO 02/081069, for example. It discloses a flexible and bendable member acting on a can bail and pressing it against the side of the can, thus preventing bail movements. This construction is extremely difficult to implement in practise, because can sizes vary a lot, both in terms of diameter and height. Moreover, cans with handles (2 of them) on opposite sides of the can are commonly available on the market. This type of situation is almost impossible to manage with the construction of the invention. For the above reasons, the construction of the patent has not been commercially utilized in commonly sold mixers. Moreover, the flexible and bendable member may be easily damaged in use. Also the slide constructed to the plate is in a risk of becoming stuck because of dirt, paint splatter and runs.

A prior art approach is known from U.S. Pat. No. 4,445,782. It discloses a separate retention ring that is moved to a locking position before mixing is started. However, from automation point of view, there are obstacles that make this difficult to implement because use of retention rings by other means than manually is complicated in members rotating in two directions. Moreover, problems relating to the can size and the location of bails or handles mentioned earlier are even more difficult here.

A further attempted solution for locking the bail has been to slip the can to different cylindrical holders. Examples of these are described in U.S. Pat. Nos. 5,788,371 and 5,437,505. The solutions are complicated in practise, because the can should be entered into and taken out of the mixer in a position typically transversal to the axis of the cylinders. This easily results in an impractically large construction. A second, more serious obstacle arises from cans of different sizes, as each size would require a separate cylinder.

Because of these difficulties, manually operated mixers are provided with detachable auxiliary means such as those mentioned above (springs, rubber bands, hooks, tapes, magnets, etc.) for locking bails or handles in place. Sometimes these auxiliary means manually fastened to the bail are built as an integral part of the machine plate, as in US2007/0211561 A1, for example.

In automated lines, where can sizes are almost standard, it is possible to use more restricted automated means for fastening a bail, such as fixed magnets or strings tightened between the plates.

### SUMMARY OF THE INVENTION

It is thus an object of the invention to provide an apparatus that allows the above problems to be solved. The object of the invention is achieved by an apparatus characterized in that the restraint comprises two rigid restraint portions on opposite sides of the can and a flexible restraint portion arranged between them.

The present invention aims at eliminating the drawbacks mentioned at the beginning, the basic idea being that the bail is not necessarily fastened nor permanently pressed at all to the side of the can by any means, member or device. In practise it is not necessary to lock can bails or handles in place because they are not going to be broken unless they hit a solid structure, typically the frame structure of the mixer, for example. On the other hand, uncontrolled movement of the bail causes noise, which is not dangerous as such, but unpleasant to those close by. Practical experiments have shown that restricted movement of bails or handles is not harmful in any way.

These starting points have led to the conclusion that the construction of the invention eliminates in a sufficient manner basically all disadvantages that have emerged, without moving parts. In addition, the apparatus of the invention in practice allows to control cans of all diameters and heights, and does not prevent the use of cans without bails either. The apparatus of the invention also substantially frees the lower plate to move for completely indefinite distances in relation to the mixer. This allows the plate to be moved for loading and unloading of the can to a more preferable position as regards ergonomics and automation. The apparatus of the invention is simple and economical to manufacture.

The apparatus is reliable and economical in use and suitable for all mixers, from manually operated ones to automated mixer lines. It is independent of can diameters or heights and resistant to soiling.

### LIST OF FIGURES

In the following the invention will be disclosed with reference to a preferred embodiment example and to the accompanying drawings, in which

FIGS. 1A and 1B are top views of the apparatus of the invention in association with a can having one bail;

FIGS. 2A and 2B are side views of the apparatus of the invention in association with a can having one bail;

FIGS. 3A and 3B are top views of the apparatus of the invention in association with a can having two handles;

FIGS. 4A and 4B are side views of the apparatus of the invention in association with a can having two handles; and

FIG. 5 is a rear view of the apparatus of the invention in association with a can having two handles.

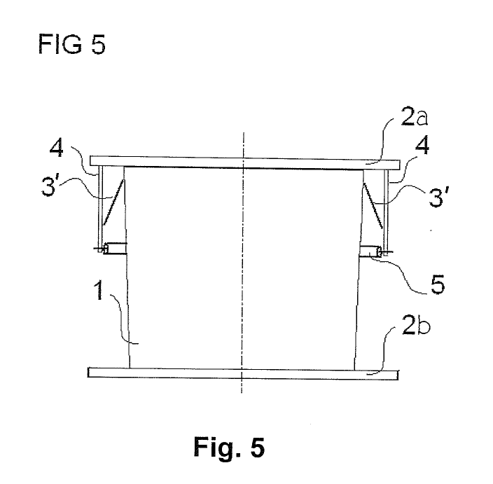

### DETAILED DISCLOSURE OF THE INVENTION

The drawings that will be referred to show an apparatus of the invention for restricting the movements of a can with contents to be mixed, such as a paint can 1, a bail 3 or handles 3′ in a mixer in which the can 1 is pressed in the direction of its longitudinal axis between two support surfaces 2a and 2b for the duration of mixing movements. Only the support surfaces 2a and 2b of the mixer are shown, the surfaces being typically disc-like plates. The apparatus of the invention itself comprises a restraint or restraint arrangement 4, 5 provided on one and only one of the surfaces 2a or 2b and extending on selected portions of the periphery and height of the can 1, the bail 3 or handles 3′, when fastened to the mixing position, being at least partly at this restraint 4, 5 and within it. In this embodiment example the restraint 4, 5 is arranged to the upper support surface 2a of the mixer and comprises two rigid restraint portions 4 on opposite sides of the can 1 and a flexible restraint portion 5 between them. The rigid restraint portions 4 are flange-like or plate-like or wire-like portions in the direction of the side of the can 1, and they are strongly fastened to the upper support surface 2a or integrated therewith. The flexible restraint portion 5 may be a helical spring or elastic plastic material, for example, suitable for the purpose.

Although in this preferred embodiment example the restraint 4, 5 is described as being associated with the upper support surface 2a, of course it could also be arranged to the lower support surface 2b, if it extends to cover the bail 3 or the handles 3′ in the manner described above.

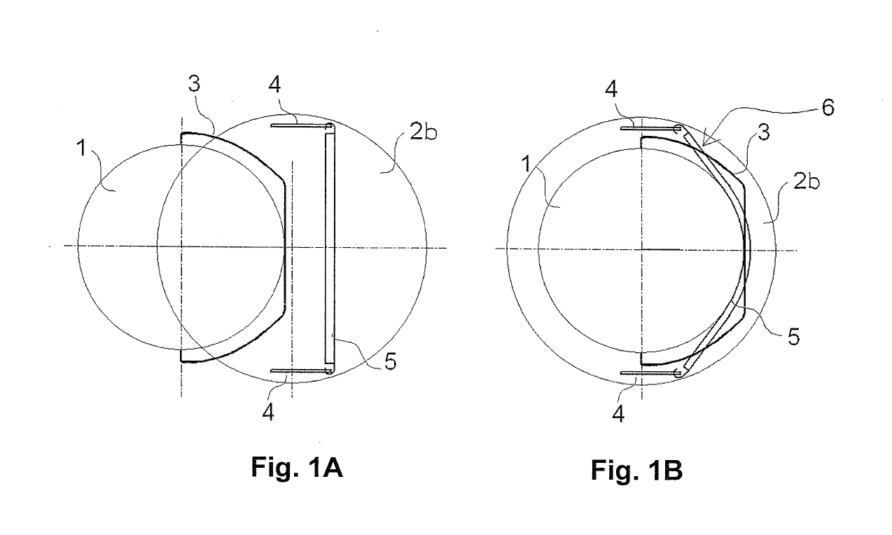

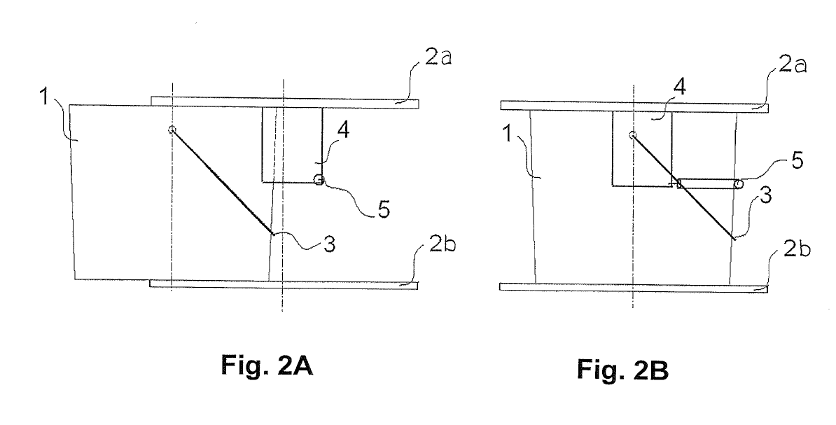

FIGS. 1A and 1B show a top view of the can 1 as it is being pushed between the support surfaces 2a and 2b so that the points where the bail 3 is attached to the can 1 are left within the rigid restraint portions 4, the flexible restraint portion 5 stretching and forming an adapting restraint for the bail 3 against the can 1. These figures do not show the upper support surface 2a but only the restraint 4, 5 of the invention attached thereto. The same is represented as a side view in FIGS. 2A and 2B.

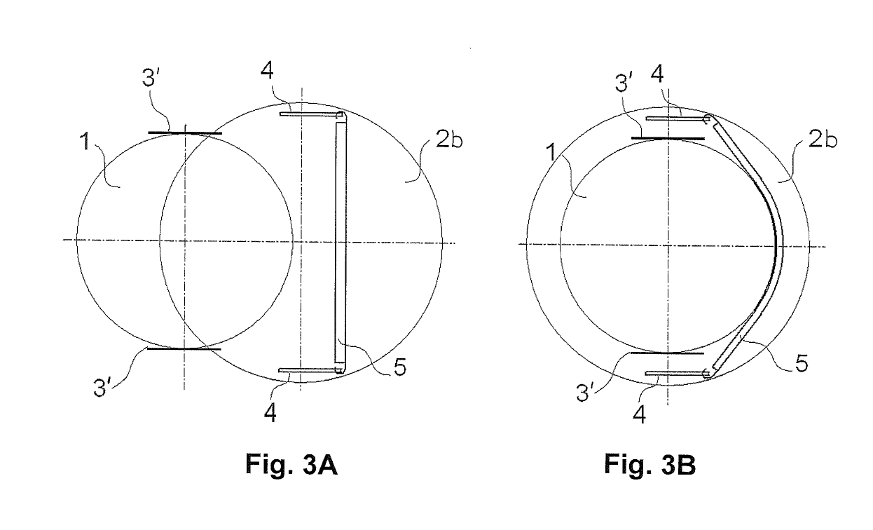

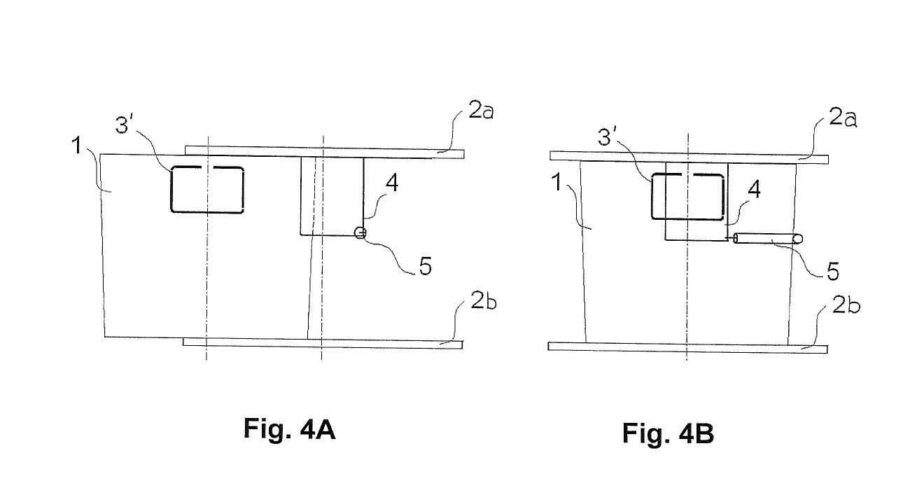

The description of FIGS. 3A, 3B and 4A, 4B corresponds otherwise to that of the previous figures except that the bail 3 of the can 1 is replaced by two handles 3′ on opposite sides of the top part of the can 1. These handles 3′ stay in a space between the rigid restraint portions 4 and the can 1, the flexible restraint portion 5 stretching and pressing only against the wall of the can 1.

The invention is thus suitable for handling both cans 1 provided with bails 3 and those with handles 3′, the aim being to prevent harmful swinging of the bails 3 or handles 3′ in the mixer during the mixing. The apparatus of the invention shown in the drawings allows a restricted movement of the bails 3 or handles 3′ particularly between the rigid restraint portions 4 of the wall, but prevents the bails 3 or handles 3′ from being damaged and caught on mixer parts moving in relation to the can 1, and reduces noise caused by the bails 3 or the handles.

The apparatus of the invention operates fully automatically and suits all can diameters or heights when the can 1 is placed into a mixer provided with the apparatus. Small cans do not even have bails 3 or handles 3′, hence the apparatus has no (harmful) effect on them. When the support surfaces 1a and 2b of small cans are pressed towards each other, the flexible restraint portion 5 always jumps, when tightening, to the side of the can even if the can was not at all in contact with the flexible restraint portion 5 at the start of the pressing. The flexible restraint portion 5 thus always accomplishes the task it is supposed to.

The above specification is only meant to illustrate the inventive idea. A skilled professional is thus able to modify its details within the scope of the accompanying claims.

1-6. (canceled)

7. An apparatus for restricting movements of at least one of:
(i) a bail; and
(ii) handles
of a can with contents to be mixed in a mixer, wherein, in the mixer, the can is pressed between two support surfaces in a direction along its longitudinal axis for duration of mixing movements, the can having a periphery and a height, said apparatus comprising:
at least one restraint arranged on at least one of the support surfaces and extending to selected portions on the periphery and the height of the can, the at least one of a bail and handles being at least partly at said at least one restraint and within it;
wherein said at least one restraint in turn comprises:
two rigid restraint portions on opposite sides of the can; and
a flexible restraint portion arranged between said two rigid restraint portions.

8. The apparatus as claimed in claim 7, wherein said two support surfaces comprise upper and lower support surfaces, and wherein said restraint is arranged to said upper support surface.

9. The apparatus as claimed in claim 7, wherein said two support surfaces comprise upper and lower support surfaces, and wherein said restraint is arranged to said lower support surface.

10. The apparatus as claimed in claim 7, wherein said rigid restraint portions are flange-like.

11. The apparatus as claimed in claim 7, wherein said rigid restraint portions are plate-like.

12. The apparatus as claimed in claim 7, wherein said rigid restraint portions are wire-like.

13. The apparatus as claimed in claim 7, wherein said flexible restraint portion comprises a helical spring.

14. The apparatus as claimed in claim 7, wherein said flexible restraint portion is formed of an elastic material.
